(19) United States
(12) Patent Application Publication
(10) Pub. No.: US 2026/0099575 A1
(43) Pub. Date: Apr. 9, 2026

(54) User Equipment Configuration for Anti-Theft

(71) Applicant: Apple Inc., Cupertino, CA (US)

(72) Inventors: Ahmed MOUSTAFA, Unterhaching (DE); Ahmed M. SOLIMAN, Munich (DE)

(21) Appl. No.: 19/113,054

(22) PCT Filed: Sep. 14, 2023
(86) PCT No.: PCT/US2023/032707

§ 371 Date: Mar. 19, 2025

Related U.S. Application Data
(60) Provisional application No. 63/376,655, filed on Sep. 22, 2022.

(51) Int. Cl. G06F 21/32; H04W 12/06; H04W 12/126

(52) U.S. Cl. CPC G06F 21/32; H04W 12/06; H04W 12/126

(57) ABSTRACT

procedure for a user to unlock the UE, identify the user as a suspicious user attempting to unlock the UE and perform an operation in response to the identifying the suspicious user. The identification procedure may include a face identification of the user.

### PRIORITY/INCORPORATION BY REFERENCE

This application claims priority to U.S. Provisional Application Serial No. 63/376, 655 filed on Sep. 22, 2022 and entitled “User Equipment Configuration for Anti-Theft,” the entirety of which is incorporated herein by reference.

### BACKGROUND

A user equipment (UE) may be stolen without trace or proper measures to prevent possible theft. Under conventional circumstances, the current protection for the UE is to prevent the person who stole the device from flushing the current operating system. Additionally, the UE can be easily switched off when it is stolen to stop reporting its location via subscriber identity module (SIM) card assuming the UE is not connected to other devices. However, these existing solutions fail to alert the user in a timely manner when the UE is stolen and consequently fails to prevent UE loss or theft.

### SUMMARY

Some exemplary embodiments are related to an apparatus of a user equipment (UE), the apparatus having processing circuitry configured to perform an identification procedure for a user to unlock the UE, identify the user as a suspicious user attempting to unlock the UE and perform an operation in response to the identifying the suspicious user.

Other exemplary embodiments are related to a method, including performing an identification procedure for a user to unlock a user equipment (UE), identifying the user as a suspicious user attempting to unlock the UE and performing an operation in response to the identifying the suspicious user.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary method for detecting a suspicious user of the UE according to various exemplary embodiments.

FIG. 4 shows an exemplary method for operations related to identifying a suspicious user of the UE according to various exemplary embodiments.

FIG. 5 shows an exemplary method for notifying a user through a second UE that the first UE connected to the second UE has been stolen according to various exemplary embodiments.

FIG. 6 shows an exemplary method for UE self-protection according to various exemplary embodiments.

### DETAILED DESCRIPTION

The exemplary aspects may be further understood with reference to the following description and the related appended drawings, wherein like elements are provided with the same reference numerals. The exemplary embodiments introduce operations for implementing anti-theft features on a user equipment (UE).

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

Under conventional circumstances, when a UE is lost or stolen, the user may need to open an anti-theft service (e.g., iCloud) on another device to determine the location of the lost UE. Additionally, the user may play a sound on the lost UE to possibly locate the lost UE if it is in close proximity to the user. However, if the user is unable to find the UE, the user may mark the UE as lost on the anti-theft service (or other available service) and erase the information on the lost UE for security purposes. In other circumstances, when the UE (e.g., mobile device, etc.) is connected to a second UE (e.g., watch, headphones, etc.) through a Bluetooth connection (or other short range connection protocol), the second UE may recognize that the UE is not in its vicinity. For instance, when a user using a first UE and a second UE connected through Bluetooth connection moves away from the first UE (e.g., beyond the range of the short range connection protocol), the user receives an alert on the second UE alerting the user that the first UE is outside of the user's proximity.

However, the conventional approach for notifying a user of the current location of the UE or alerting the user of theft presents some drawbacks. In one scenario, the existing solution only prevents the person who stole the device from flushing the current operating system. In another scenario, the UE may be easily switched off by the thief to stop reporting its location via SIM card or prevent the UE from being traceable. In a further scenario, thew UE may not be configured to perform any locking or halting functionality if the UE detects a different user (e.g., face ID detects different facial configuration other than the registered user) until the user set the UE as lost on the anti-theft service. In another scenario, when the UE is not connected to another UE via Bluetooth connection, the user may be unaware that the UE is stolen or lost until after a long period of time.

The exemplary embodiments introduce techniques for reducing the risk of UE robbery and enhancing user alerts related to any detected robbery. In some exemplary embodiments, the UE will implement early detection features to notify the user immediately after the UE is stolen. In another example, the UE will activate features that will prevent the person who stole the device from accessing the UE. Those skilled in the art will understand that these features are only exemplary and that a combination of any of these techniques, or any other appropriate techniques may be utilized.

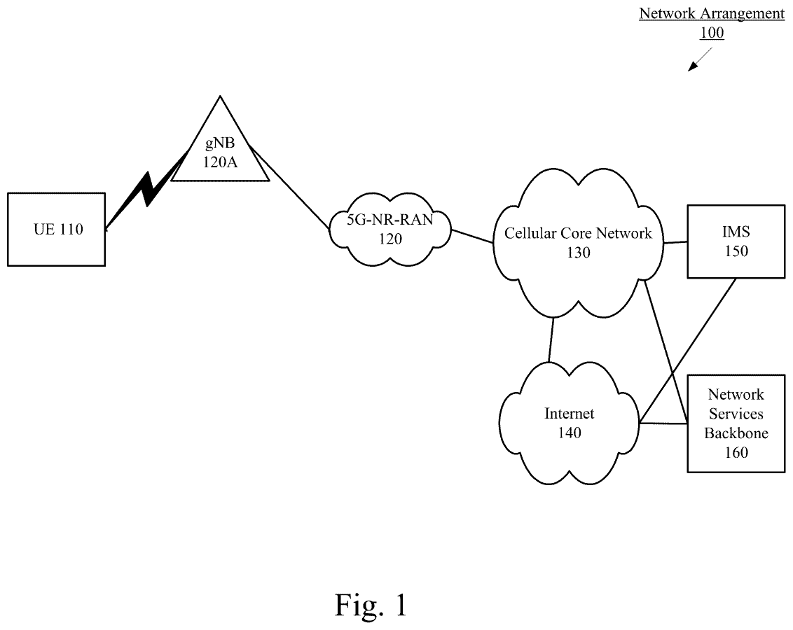

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.). However, the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of cellular network that may be deployed a network carrier (e.g., Verizon, AT&T, T-Mobile, etc.). The 5G NR RAN 120 may include, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., base station 120A of the 5G NR-RAN 120). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be an interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

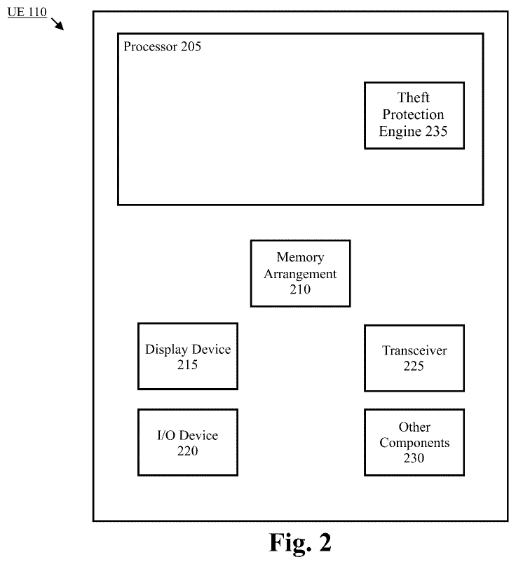

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, one or more cameras for capturing images, etc.

The processor 205 may be configured to execute a plurality of engines of the UE 110. For example, the engines may include a theft protection engine 235. The theft protection engine 235 may perform various operations related to the alerting the user of theft as described herein. These operations may include, but are not limited to, implementing a feature to register face identification (ID) for authorized users, identifying an unauthorized user based on the face recognition, triggering an alert after an unauthorized user is identified, saving the image of the unauthorized user, transferring the image to an anti-theft service, alerting other UEs connected to the UE of the current state of the UE, implementing a feature to prevent the unauthorized user from accessing the UE and maintaining the UE in a connected state to provide locations of the UE rapidly. Each of these various operations will be described in greater detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs.

The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

Throughout this description, the term “user” will be used. The individual(s) who are authorized users of the UE will be described as “authorized user(s) .” The individual(s) that stole the device will be described as “unauthorized user(s) .” In some instances, the term “suspicious user” will be used to refer to a situation where the person attempting to access the UE may or may not be an unauthorized user. The term “trusted user” will also be used in this description. As will be described in greater detail below, a “trusted user” may include authorized users and other users who are not authorized to unlock the UE but are authorized to handle the UE. The term “user” may refer to any category of user.

Some exemplary embodiments are described with regard to scenarios in which a user attempts to access the UE using biometric data. Under conventional circumstances, an authorized user may configure a security feature on the UE. For example, the authorized user may set up his/her face ID as a security feature to easily unlock the UE based on recognition of the face ID of the authorized user. The conventional manner of setting up a face ID and capturing the image of user's faces using (e.g., using a camera (other components 230) of the UE) for the purposes of face ID and unlocking the UE is known and will not be further described herein. However, it should be noted that the exemplary embodiments include novel extensions to the conventional manner of setting up the face ID and use of the face ID as will be described in greater detail below.

In addition, while the exemplary embodiments are described with reference to using facial images and face ID, those skilled in the art will understand that the exemplary embodiments may be extended to other types of biometric identification of users, e.g., fingerprints, retinal scans, etc.

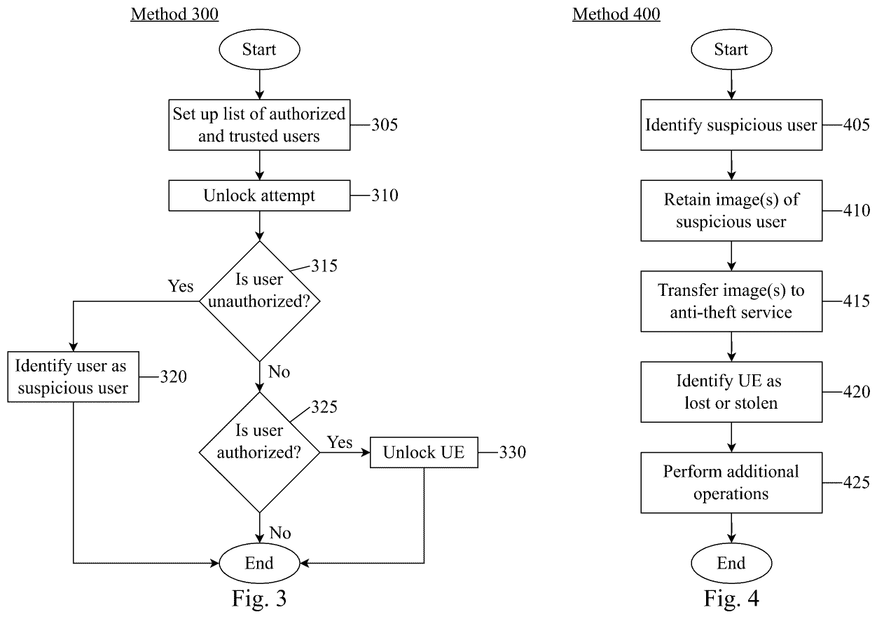

FIG. 3 shows a method 300 for detecting a suspicious user on the UE according to various exemplary embodiments. The method 300 will be described with regard to the network the UE 110 of FIG. 2. The method 300 allows the UE 110 to distinguish between authorized user(s), e.g., those users that are allowed to unlock the UE 110, trusted user(s), e.g., users who are not authorized to unlock the UE 110 but are authorized to handle the UE 110 and unauthorized user(s), e.g., those users that are not allowed to unlock or handle the UE 110.

In 305, an authorized user may configure a feature on the UE 110 that registers face IDs for authorized users and trusted users through the display device 215 of the UE 110. For example, the authorized user may first identify a list of authorized users that may be authorized to unlock the UE 110 using their face ID. This list may include, for example, the authorized user's spouse, one or more persons in the authorized user's company if the UE 110 is a company issued UE, etc. The authorized user may then identify a list of trusted users that may be authorized to handle the UE 110 but are not authorized to using their face ID. This list may include, for example, the authorized user's family members, the authorized user's roommates, etc. Thus, in the exemplary embodiments, the authorized user may configure the UE 110 to register the face ID for the list of authorized users and trusted users on the UE 110.

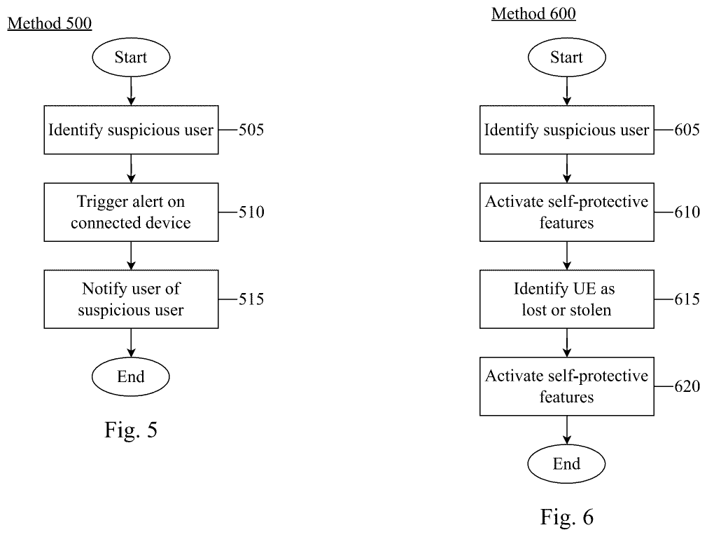

In 310, a user may attempt to unlock the UE 110 using face ID, e.g., a user picks up the UE 110 with the camera facing the user's face, fingerprint button, etc. In 315, the UE 110 determines whether the user is an unauthorized user based on the user attempt to unlock the UE 110. For instance, a user may attempt to unlock the UE 110 using face ID. The UE 110 may compare the captured face of the user to the list of authorized and trusted users registered on the UE 110. If the UE 110 cannot identify the user as an authorized or trusted user, in 320, the UE 110 will identify the user as a suspicious user. Based on this identification of a suspicious user, the UE 110 may perform additional actions. Examples of these additional actions are described with reference to FIGS. 4 and 5 below.

Returning to the method 300, if the UE 110 identifies the captured face from the list of authorized or trusted users, the UE 110, in 325, will determine if the user is an authorized user or a trusted user. If the user is a trusted user, e.g., the user is allowed to handle the UE 110 but not unlock the UE 110, the method 300 will end because the UE 110 will not be unlocked, but the UE 110 will not identify the user as a suspicious user because the user is allowed to handle the UE 110. On the other hand, if the user is identified as an authorized user, in 330, the UE 110 will unlock for the user.

Thus, the exemplary method 300 may be used to identify suspicious users that are handling the UE 110. However, just because the user is suspicious does not necessarily mean that the user is unauthorized, e.g., an authorized user can ask a friend who is not an authorized or trusted user to hand them the UE 110. As described above, when a suspicious user is identified, the UE 110 may perform additional actions to determine if the user is an unauthorized user.

FIG. 4 shows an exemplary method 400 for operations related to identifying a suspicious user of the UE 110 according to various exemplary embodiments. The method 400 will be described with regard to the network arrangement 100 of FIG. 1, the UE 110 of FIG. 2 and the method 300 of FIG. 3.

In 405, the UE 110 identifies a user as a suspicious user. As described above, the method 300 may be used to identify a user as a suspicious user. However, it should be understood that there may be other manners of identifying a suspicious user and the method 400 may be implemented using these other manners.

In 410, after the UE 110 detects a suspicious user, the UE 110 may be configured to retain (e.g., save) the captured image of the suspicious user. This image may be the image that was captured by the UE 110 for the purposes of the face ID operation. However, after identifying the user as a suspicious user, the UE 110 may be configured to capture additional images of the suspicious user. As described above, an authorized user may set up the configuration of the face ID for the UE 110. Part of this configuration may include saving one or more images of suspicious users in a timely manner.

In 415, the UE 110 may be configured to transfer the image of the suspicious user to an anti-theft service. The anti-theft service may be a service offered by the manufacturer of the UE 110, by the network provider of the cellular network, by a third party supplier of services, etc. The anti-theft service may be one of the services offered in the network services backbone 160 that are used extend the functionalities of the UE 110. For example, in addition to the exemplary functionalities described herein for the anti-theft service, the anti-theft service may keep track of the location of the UE 110 as long as the UE 110 is powered on. Those skilled in the art will understand the various manners of keeping track of the location the UE 110 and this is outside the scope of the present description.

In the exemplary embodiments, the image(s) of the suspicious user may be transferred to the anti-theft service using a secure communication protocol. As described above, the suspicious user may not be an unauthorized user (e.g., a thief) and therefore, for privacy concerns, the image(s) should not be freely available or accessible. Further, the images that are transferred to the anti-theft service that are not identified as an unauthorized user should be erased after a period of time.

In 420, the UE 110 is identified as lost or stolen with the anti-theft service. For example, when the authorized user realizes that the UE 110 is lost or stolen, the authorized user may report to the anti-theft service that the UE 110 is currently lost or stolen. When this occurs the anti-theft service may then access the image(s) of the unauthorized user. These image(s) may then be transferred to the authorized user to attempt to identify the unauthorized user. The authorized user may also send these images to other entities such as law enforcement if the UE 110 is stolen.

It should be understood that the authorized user will identify the UE 110 as lost or stolen using a different device because the authorized user does not have access to the lost or stolen UE 110. This also includes the anti-theft service sending the image(s) to the authorized user. However, part of 420 may also include the anti-theft service notifying the UE 110 that it has been identified as being lost or stolen. When the UE 110 is notified that it has been identified as lost or stolen, the UE 110 may be configured to perform additional operations.

Prior to describing the additional operations, a variation of the flow described above is described. For example, the UE 110 may retain the image(s) as described in 410. However, the transfer of the images(s) to the anti-theft service described in 415 may not happen until the UE 110 is notified that it is identified as lost or stolen. That is, the UE 110 may retain the image(s) until the UE 110 is lost or stolen and then transfers the image(s) via secure communication protocol to the anti-theft service, e.g., 415 occurs after 420.

In 425, the UE 110 may be configured to gather additional information when the UE 110 has been notified that it has been identified as lost or stolen. For example, the UE 110 may collect additional information such as audio (of the suspicious user, ambient audio, etc., fingerprints, ambient atmospheric pressure, etc. to help identify the unauthorized user in possession of the UE 110 or the location of the UE 110. This additional information may also be reported to the anti-theft service using a secure communication protocol.

FIG. 5 shows a method 500 for notifying a user through a second UE that the first UE connected to the second UE has been stolen according to various exemplary embodiments. The method 500 will be described with regard to the network arrangement 100 of FIG. 1, the UE 110 of FIG. 2 and the method 300 of FIG. 3.

In the exemplary embodiment, a user may have access to multiple UEs and/or devices (e.g., mobile device, watch, headphones, etc.) that are connected via a Bluetooth connection (or other short range connection protocol) at the same time. Thus, the user may perform similar activities and/or receive similar notifications on the connected UEs. In an example, when a user receives a voice call on the mobile device, the other devices (e.g., watch, headphones,) connected to the mobile device may notify the user of the incoming voice. Additionally, the user may answer the voice call through any of the devices provided they are connected via the Bluetooth connection. In another example, the user may receive notifications (e.g., text message alert, email alert, etc.) on the UEs connected via Bluetooth connection. Thus, when the user is away from the UE 110 (e.g., mobile phone) but is connected via another device such as a headphone, the user may be alerted via the headphone of incoming voice call or messaging which prompts the user to check the UE 110. This connection with another device may be used in the context of identifying a suspicious user as will be described in detail below with respect to the method 500.

In 505, the UE 110 identifies a user as a suspicious user. As described above, the method 300 may be used to identify a user as a suspicious user. However, it should be understood that there may be other manners of identifying a suspicious user and the method 500 may be implemented using these other manners.

In 510, after the UE 110 detects a suspicious user, the UE 110 may be configured to trigger an alert for the user. As mentioned above, the user may have access to other devices that are connected to the UE 110 via a Bluetooth connection. Thus, in the exemplary embodiments, the UE 110 may trigger an alert for the connected UEs regarding its current state. For example, when the UE 110 identifies the suspicious user, the UE 110 may send an alert to any devices to which it is currently connected.

In 515, the UEs and/or devices connected to the UE 110 may generate an alert for the user indicating that UE 110 has been stolen and/or accessed by an authorized user. For example, the user may receive an audio or vibration alert when an unauthorized user attempts to unlock the stolen UE 110 using face ID. Thus, in the exemplary embodiments, the user may receive an early signal that the UE 110 is stolen that allows the user to act swiftly in finding the stolen UE 110.

FIG. 6 shows a method 600 for UE self-protection according to various exemplary embodiments. The method 600 will be described with regard to the network arrangement 100 of FIG. 1, the UE 110 of FIG. 2 and the method 300 of FIG. 3.

In 605, the UE 110 identifies a user as a suspicious user. As described above, the method 300 may be used to identify a user as a suspicious user. However, it should be understood that there may be other manners of identifying a suspicious user and the method 500 may be implemented using these other manners.

In 610, after the UE 110 detects a suspicious user, the UE 110 may be configured to activate self-protection features. Prior to detecting the suspicious user, the UE 110 may be preconfigured to activate the self-protection features any time a suspicious user attempts to unlock the UE 110. The self-protection features may prevent an unauthorized user from taking actions that will prevent the authorized user from finding that UE 110. For example, an unauthorized user may switch off the UE 110, place the UE 110 in airplane mode, turn off a data connection, Bluetooth, or Wi-Fi, etc. when the unauthorized user is in possession of the UE 110. Thus, in the exemplary embodiments, when the UE 110 detects a suspicious user, the UE 110 may be configured to activate the self-protection features to prevent an unauthorized user from taking these actions.

In 615, the UE 110 is identified as lost or stolen with the anti-theft service. For example, when the authorized user realizes that the UE 110 is lost or stolen, the authorized user may report to the anti-theft service that the UE 110 is currently lost or stolen. When this occurs the anti-theft service may then notify the UE 110 that the UE 110 has been identified as lost or stolen.

In 620, the UE 110 may be configured to remain in the connected state after the self-protection features are activated. In the exemplary embodiments, when the user marks the UE 110 as stolen when the user is not in possession of the UE 110, the self-protection features may be automictically activated via the anti-theft service identifying the UE 110. Once the self-protection features are activated, the UE 110 may be configured to stay connected and may transmit location data at a faster rate. It should be understood that the self-protection features identified in 610 may include the same self-protection features as 620 or may include different self-protection features.

### EXAMPLES

In a first example, a method performed by a user equipment (UE), comprising performing an identification procedure for a user to unlock the UE, identifying the user as a suspicious user attempting to unlock the UE and performing an operation in response to the identifying the suspicious user.

In a second example, the method of the first example, wherein the identification procedure comprises a face identification of the user.

In a third example, the method of the first example, wherein identifying the user as a suspicious user comprises comparing a captured image of the user with images of authorized users and trusted users of the UE.

In a fourth example, the method of the first example, wherein the operation comprises saving an image of the suspicious user.

In a fifth example, the method of the fourth example, wherein the operation further comprises transferring the image to an anti-theft service.

### In a Sixth Example, the Method of the Fifth Example, wherein the image is accessible from the anti-theft service after an authorized user of the UE marks the UE as lost or stolen.

In a seventh example, the method of the fifth example, wherein the images are transferred via a secure communication protocol.

In an eighth example, the method of the fourth example, wherein the operation further comprises collecting additional images of the suspicious user.

In a ninth example, the method of the fourth example, wherein the operation further comprises the UE collecting additional information.

In a tenth example, the method of the ninth example, wherein the additional information comprises audio of the suspicious user, ambient audio, as fingerprint of the suspicious user or ambient atmospheric pressure.

In an eleventh example, the method of the first example, wherein the operation comprises triggering an alert on a device connected to the UE via a short range connection.

In a twelfth example, the method of the first example, wherein the operation comprises preventing the UE from being turned off the UE, preventing the UE from being switched to an airplane mode or preventing a data connection of the UE from being turned off.

In an thirteenth example, the method of the first example, wherein the identification procedure comprises capturing a fingerprint of the user.

In an fourteenth example, the method of the thirteenth example, wherein identifying the user as a suspicious user comprises comparing the captured fingerprint of the user with fingerprints of authorized users and trusted users of the UE.

In an fifteenth example, the method of the fourteenth example, wherein the operation comprises capturing and saving an image of the suspicious user.

In an sixteenth example, the method of the fifteenth example, wherein the operation further comprises transferring the image to an anti-theft service.

### In an Seventeenth Example, the Method of the Sixteenth example, wherein the image is accessible from the anti-theft service after an authorized user of the UE marks the UE as lost or stolen.

In an eighteenth example, a processor configured to perform any of the methods of the first through seventeenth examples.

In a nineteenth example, a user equipment (UE) comprising a transceiver configured to communicate with a network and a processor communicatively coupled to the transceiver and configured to perform any of the methods of the first through seventeenth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described methods may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
perform an identification procedure for a user to unlock the UE;
identify the user as a suspicious user attempting to unlock the UE; and
perform an operation in response to the identifying the suspicious user.

2. The apparatus of claim 1, wherein the identification procedure comprises a face identification of the user.

3. The apparatus of claim 1, wherein, to identify the user as a suspicious user, the processing circuitry is further configured to:
compare a captured image of the user with images of authorized users and trusted users of the UE.

4. The apparatus of claim 1, wherein the operation comprises saving an image of the suspicious user.

5. The apparatus of claim 4, wherein the operation further comprises transferring the image to an anti-theft service.

6. The apparatus of claim 5, wherein the image is accessible from the anti-theft service after an authorized user of the UE marks the UE as lost or stolen.

7. The apparatus of claim 5, wherein the images are transferred via a secure communication protocol.

8. The apparatus of claim 4, wherein the operation further comprises collecting additional images of the suspicious user.

9. The apparatus of claim 4, wherein the operation further comprises the UE collecting additional information.

10. The apparatus of claim 9, wherein the additional information comprises audio of the suspicious user, ambient audio, as fingerprint of the suspicious user or ambient atmospheric pressure.

11. The apparatus of claim 1, wherein the operation comprises triggering an alert on a device connected to the UE via a short range connection.

12. The apparatus of claim 1, wherein the operation comprises preventing the UE from being turned off the UE, preventing the UE from being switched to an airplane mode or preventing a data connection of the UE from being turned off.

13. The apparatus of claim 1, wherein the identification procedure comprises capturing a fingerprint of the user.

14. The apparatus of claim 13, wherein, to identify the user as a suspicious user, the processing circuitry is further configured to:
compare the captured fingerprint of the user with fingerprints of authorized users and trusted users of the UE.

15. The apparatus of claim 14, wherein the operation comprises capturing and saving an image of the suspicious user.

16. The apparatus of claim 15, wherein the operation further comprises transferring the image to an anti-theft service.

17. The apparatus of claim 16, wherein the image is accessible from the anti-theft service after an authorized user of the UE marks the UE as lost or stolen.

18. A method, comprising:
performing an identification procedure for a user to unlock a user equipment (UE) ;
identifying the user as a suspicious user attempting to unlock the UE; and
performing an operation in response to the identifying the suspicious user.

19. The method of claim 18, wherein the identification procedure comprises a face identification of the user.

20. The method of claim 18, further comprising:
comparing a captured image of the user with images of authorized users and trusted users of the UE.
